(19) United States
(12) Patent Application Publication
(10) Pub. No.: US 2012/0284524 A1
(43) Pub. Date: Nov. 8, 2012

(54) LOW OVERHEAD NONCE CONSTRUCTION FOR MESSAGE SECURITY

(75) Inventor: Jin-Meng HO, Plano, TX (US)

(73) Assignee: TEXAS INSTRUMENTS INCORPORATED, Dallas, TX (US)

(21) Appl. No.: 13/463,230

(22) Filed: May 3, 2012

Related U.S. Application Data
(60) Provisional application No. 61/482,021, filed on May 3, 2011.

(51) Int. Cl. H04L 9/32

(52) U.S. Cl. 713/181

(57) ABSTRACT

A system and method for data encryption/decryption and authentication using a relatively long security sequence number (SSN). The SSN is used both to encrypt data and to compute a message integrity code (MIC). However, the entire SSN need not be transmitted from sender device to receiver device. For example, only the lowest order octet of the SSN is transmitted to the receiver device. The receiver device computes the entire SSN based on the received portion.

### CROSS-REFERENCE TO RELATED APPLICATION

The present application claims priority to U.S. Provisional Patent Application No. 61/482,021, filed on May 3, 2011 (Attorney Docket No. TI-70815PS); which is hereby incorporated herein by reference.

### BACKGROUND

Messages exchanged between two or more parties in a wireless network or over the Internet are vulnerable to eavesdropping and manipulation by other parties. Security is required to protect the confidentiality and integrity of the message exchanges. Typically, messages are protected through encrypting and authenticating the messages with a pairwise temporal key (PTK) or session key that is shared between the intended parties.

However, even if a malicious third party cannot decrypt an encrypted message or forge an authenticated message because it does not have the PTK, the third party can cause other problems during a communication session between a sender and intended recipient. By capturing encrypted and/or authenticated messages and resending such message one or more additional times to the intended recipient (i.e. replaying the messages), a malicious third party may cause the intended recipient to act on the same single message multiple times. Such a message replay attack may result in a dangerous condition depending upon the actions that are triggered in the intended recipient by the replayed message. For example, if the intended recipient takes a medical action in response to an original message, the replayed message(s) would result in taking excessive actions, such as causing the recipient to over-dispense medication.

### SUMMARY

A system and method for data encryption/decryption and authentication using a multi-octet security sequence number (SSN). The SSN is used both to encrypt data and to compute a message integrity code (MIC). However, the entire SSN need not be transmitted from the sender device to the receiver device. For example, only the lowest order octet of the SSN is transmitted to the receiver device. The receiver device computes the entire SSN based on the received portion.

Some embodiments are directed to a method for authenticating and encrypting data for secure communications between devices. This method may include generating a nonce to include a multi-octet security sequence number (SSN), encrypting plaintext payload blocks based on the nonce to form encrypted payload blocks, creating a message integrity code (MIC), forming a frame including the encrypted payload blocks, the MIC, and a lower order octet of the SSN, but not the entire SSN, and causing the frame to be transmitted.

Another embodiment is directed to a method for authenticating and decrypting received data. This method includes receiving a frame containing encrypted blocks and a portion, but not all, of a security sequence number (SSN), computing the entire SSN based on the received portion, and decrypting and authenticating the encrypted blocks using the entire SSN.

Yet other embodiments are directed to a device that includes an encryption and authentication engine coupled to a transmitter. The encryption and authentication engine uses plaintext data blocks as its input and generates encrypted data blocks and a MIC using a key and a multi-octet security sequence number (SSN) to form a frame. The frame formed by the encryption and authentication engine contains the encrypted data blocks, a portion of the SSN, but not the entire SSN, and the MIC. The frame is provided to the transmitter which transmits the frame to another device.

Yet other embodiments are directed to a device that includes a receiver to receive a frames including encrypted data blocks, a portion of a security sequence number (SSN), but not the entire SSN, and a MIC. The device also includes a decryption and authentication engine to compute the entire SSN based on the received SSN portion and to decrypt and authenticate the encrypted data blocks using the entire SSN.

### BRIEF DESCRIPTION OF THE DRAWINGS

Various embodiments of the invention are described in reference to the figures in which:

FIG. 1 shows a system diagram of a sender and a receiver in accordance with various embodiments of the invention;

FIG. 2 illustrates the sequencing of a security sequence number (SSN) in accordance with various embodiments;

FIG. 3 is a block diagram of an exemplary embodiment of a device for providing secure communications with another device in accordance with an embodiment of the invention;

FIG. 4 illustrates a block (BO) that is the first input block to a cipher block chaining (CBC) for message integrity code (MIC) computation in accordance with an embodiment of the invention;

FIG. 5 illustrates an exemplary format for constructing payload blocks for use in a message authentication and encryption process in accordance with an embodiment of the invention;

FIG. 6 illustrates counter blocks that are used for inputs to a cipher block chaining-based MIC computation and to a counter mode encryption in accordance with an embodiment of the invention;

FIG. 7 illustrates an exemplary format for constructing a nonce used in a message authentication and encryption/decryption process in accordance with an embodiment of the invention;

FIG. 8 illustrates a cipher text generation procedure and a format of an encrypted frame payload in an encrypted frame according to one embodiment of the invention;

FIG. 9 illustrates a plain text recovery procedure and a format of a decrypted frame payload in a decrypted frame according to one embodiment of the invention;

FIG. 10 illustrates a procedure for message integrity code (MIC) calculation according to one embodiment of the invention;

FIG. 11 illustrates an exemplary format for a frame format in accordance with an embodiment of the invention;

FIG. 12 illustrates an exemplary format for a frame body in accordance with an embodiment of the invention;

FIG. 13 shows an encryption and authentication method in accordance with an embodiment of the invention; and

FIG. 14 shows a decryption and authentication method in accordance with an embodiment of the invention.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . . ” Also, the term “couple” or “couples” is intended to mean either an indirect or direct electrical connection. Thus, if a first device couples to a second device, that connection may be through a direct electrical connection, or through an indirect electrical connection via other devices and connections.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

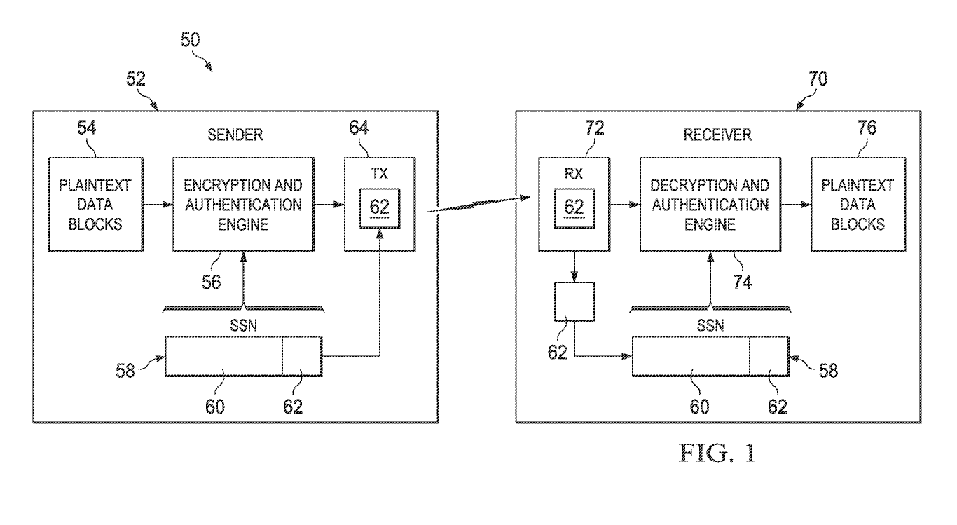

FIG. 1 shows a system 50 in which a sender device 52 transmits data, preferably wirelessly, to a receiver device 70. In the sending device, plaintext data blocks 54 may be encrypted and authenticated by an encryption and authentication engine 56 and provided to a wireless transmitter for wireless transmission to the receiver device 72. The encryption and authentication engine 56 converts the plaintext data blocks to encrypted data blocks and a message integrity code (MIC) using, among other parameters, a security sequence number (SSN) 58. The encryption and authentication engine 56 forms a frame containing the encrypted data blocks and other information such as a portion of the SSN as explained above and the MIC. The frame is then transmitted by the transmitter 64 to the receiver device 70.

The SSN serves two purposes. One purpose is for the actual encryption of the data blocks by the sending device and the corresponding decryption by the receiver device 70. The other use of the SSN is for the authentication of the frame being sent from sender to receiver. Both uses are discussed in the implementation provided below.

The SSN preferably is a multi-octet value. In one embodiment, the SSN is a 4-octet value. The SSN preferably is unique to each frame of data being transmitted and also unique for each session key used in the encryption and authentication process. That is, the SSN changes (e.g., increments) for each subsequent frame being transmitted. The SSN also changes (e.g., resets to 0) when the session key changes. For a given session key, the SSN preferably is initialized to 0 and then increments for each subsequent frame to be transmitted from the sender device 52 to the receiver device 70. Given that the SSN initializes to 0 and changes thereafter according to a known pattern (increments sequentially), it is not necessary to transmit all of the octets comprising the SSN. Thus, while the complete SSN is necessary to avoid frequent key changes, the entire SSN need not be transmitted wirelessly from the sender device to the receiver device. Instead, the receiver device 70 computes the entire SSN based on the received portion of the SSN and the known pattern for changing the SSN by the sender device 52.

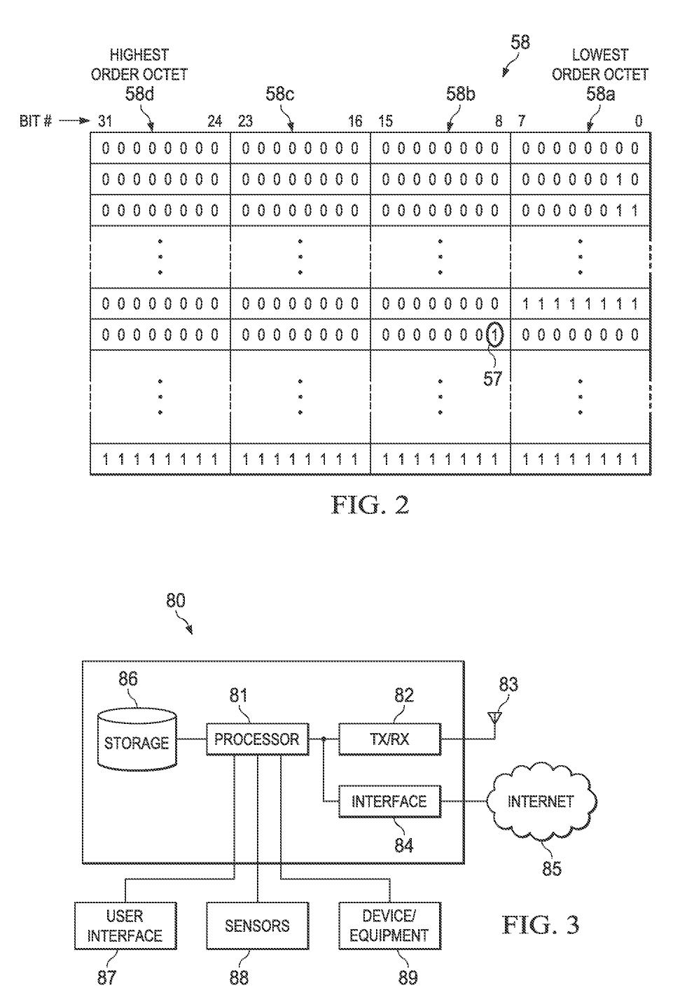

For example, for an SSN comprising 4 octets (32 bits) and that initializes to 0 for a new session key, all 32 bits will initially be 0. For the next frame, the SSN is incremented by 1 and the lowest order bit thus becomes a 1 while all higher order bits remain 0. In fact, the upper order 3 octets (bits 8 through 31) remain at a value of 0 until the lowest order octet is all 1's. Upon the next increment of the SSN, bit 8 becomes a 1 and the process repeats. This is illustrated in FIG. 2. As shown, the SSN 58 is initially all 0's and the lowest order 2 bits change as the SSN begins to increment. The lowest order 8 bits (lowest octet 58a) sequence from the value 0 to 255 while higher order three octets 58b, 58c, and 58d remain at a value of all 0's. Once the lowest order octet 58a maxes out at all 1's then, the higher order three octets increment by 1 as shown at 57.

This pattern being the case, then the receiver device 70 can compute the value of the highest order octets (e.g., octets 58b-58d) based on the value of the lowest order octet actually received, so the entire SSN need not be transmitted. The receiver device 70 monitors the value of the received lowest order octet of the SSN. As long as the value of the lowest order octet 58a continues to increase for frames from a common sender and even wraps around at its maximum value but no reaches its value shown in a received valid frame, the receiver device 70 does not alter the value of the upper order three octets 58b-58d. Otherwise, when the receiver device 70 determines that the received value of the lowest order is not higher than a previously received value of the lowest order octet (i.e., the value is the same or lower), the receiver device 70 increments the value of the highest order three octets by one. In this way, the receiver device 70 receives only a portion of the needed SSN value and computes the remaining needed portions.

Referring again to FIG. 1, the entire SSN is depicted by reference numeral 58. The SSN is shown to comprise two portions 60 and 62. Portion 62 is a lower order portion (e.g., lowest order octet), while portion 62 is a higher order portion (e.g., the highest order three octets of a 4-octet SSN). Only lower order portion 62 is provided to the transmitter 64 for wireless transmission of the frame. Thus, the receiving device 70 receives only a portion (portion 62) of the SSN and does not receive the entire SSN. The receiver device 70 (e.g., the decryption and authentication engine 74) generates the entire SSN 58, and the decryption and authentication engine 74 uses the entire SSN 58 to decrypt the received encrypted data blocks to generate plaintext data blocks 76 and authenticate the frame. In general, the decryption and authentication engine 74 may perform any act described herein as attributed to the receiver device 70 and may be implemented by a processor (e.g., processor 81).

FIG. 3 is a block diagram of an exemplary embodiment of a device 80 for providing secure communications with another device. The architecture shown may be used for either a sender device or a receiver device. In at least some embodiments, each device both sends and receives frames (i.e., bi-directional data communication). The device 80 includes a processor 81 which processes messages to be exchanged with other devices via transceiver 82 and antenna 83 and/or via wireline interface 84 coupled to the Internet or other network 85. Processor 81 preferably executes code stored in storage device 86. The encryption and authentication engine 56 and the decryption and authentication engine 74 may be implemented by the processor 81 executing code. Processor 81 may compute or select a pairwise temporal key (PTK), message integrity code (MIC), SSN, or nonce, and may encrypt or decrypt and authenticate messages. Processor 81 may also generate and process messages sent to, and received from, another device in a manner that provides anti-replay protection as disclosed herein.

Storage device 86 may be used to store cryptographic data, such as the PTK, MIC, SSN, and/or nonce. Storage device 86 preferably is secured from unauthorized access. Storage 86 may also be used to store code that is executed by processor 81. It will be understood that storage device 86 may be any applicable storage device, such as a fixed or removable RAM, ROM, flash memory, or disc drive that is separate from or integral to processor 81.

Device 80 may be coupled to other devices, such as user interface 87, sensors 88, or other devices or equipment 89. In one embodiment, device 80 is a low-power wireless node operating on, in, or around a human or non-human body to serve one or more applications, such as medical connections, consumer electronics, and personal entertainment. Device 80 may be adapted to operate in a body area network either as a node or as a hub controlling a plurality of nodes. Sensors 88 may be used, for example, to monitor vital patient data, such as body temperature, heart rate, and respiration. Equipment 09 may be, for example, a monitor or other device that receives and analyzes signals, such as a patient's temperature, heart rate, and respiration, from another node. Alternatively, equipment 09 may be a device for providing a service to a patient, such as controlling an intravenous drip, respirator, or pacemaker.

When used as a node or a hub in a body area network, the information transmitted or received by device 80 is likely to include sensitive and/or confidential medical information. Accordingly, it is important to secure any session established by device 80 to protect the messages from unauthorized parties, such as an imposter or eavesdropper. The messages transmitted or received by device 80 may also include control signals, such as signals to control distribution of medicine or operation of a respirator or pacemaker. Preferably, only authorized signals are used to control equipment 89 and other signals may be rejected or ignored to prevent, for example, unauthorized adjustments to drug distribution or respirator operation. Message communications secured with a secret PTK or session key as described herein provide the necessary level of control for such a device.

As noted above, two devices establish a communication session and exchange data messages in authenticated frames. The frames may or may not be encrypted. The messages also include provisions for defending against replay using the SSN and a message integrity code (MIC). In the exemplary system and method disclosed herein, the frames are authenticated and encrypted/decrypted based on a counter mode encryption and cipher block chaining for message integrity protection (CCM) as specified in the National Institute of Standards and Technology (NIST) Special Publication 800-38C, with the Advanced Encryption Standard (AES) forward cipher function for 128-bit keys as specified in Federal Information Processing Standard (FIPS) publication Pub 197 applied as the underlying block cipher algorithm. A shared pairwise temporal key (PTK) is used as a session key for securing frames transmitted between the devices.

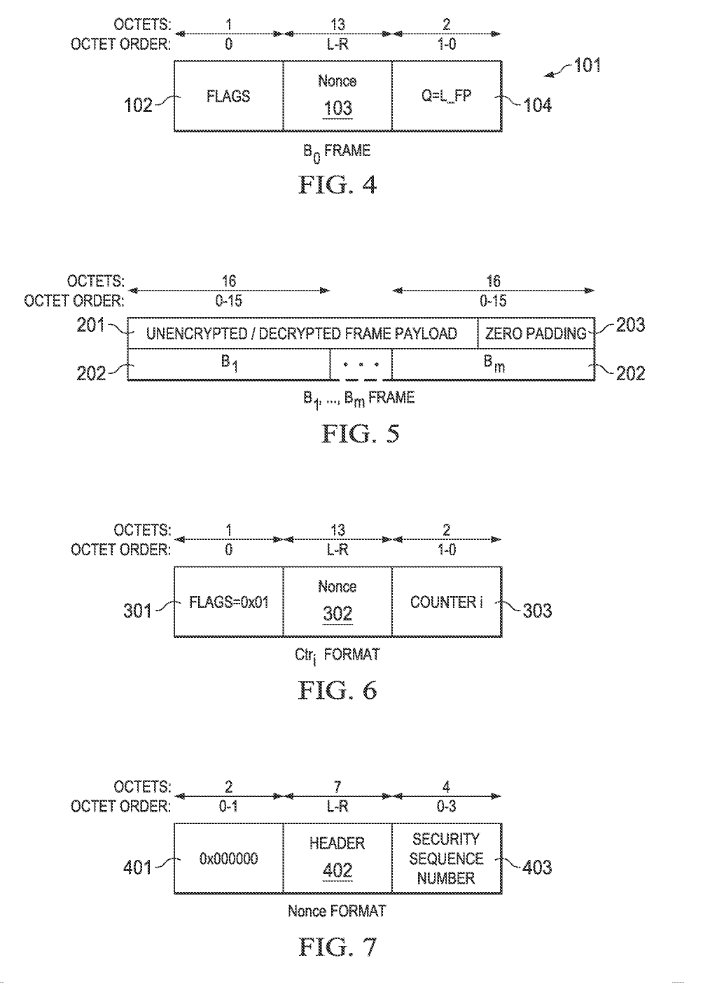

The encryption, decryption and authentication processes involve multiple steps and various type of blocks. Such blocks will now be described. FIG. 4 illustrates an initial block B₀ 101 that is the first input block applied to a cipher block chaining (CBC) for message integrity code (MIC) computation. Block B₀ 101 preferably is sixteen octets long and comprises flags field 102, nonce field 103, and Q field 104, with each of these fields encoded with the octet containing the most-significant bits on the left and the octet containing the least-significant bits on the right. Flags field 102 may define, for example, whether the message is authenticated and/or encrypted, the octet length of the MIC (parameter t in NIST Special Publication 800-38C), and the octet length of the binary representation of the frame payload octet length. According to one embodiment of the invention, Flags field is set to 0x09 if the frame payload is encrypted, or 0x49 if the frame payload is not encrypted. Nonce field 103 is defined, for example, as discussed below in connection with FIG. 7. Q field 104 is the octet length of the frame payload (L_FP).

FIG. 5 illustrates an exemplary format for constructing payload blocks for use in a frame to be transmitted to the sender device 70. The payload blocks may or may not be encrypted. The frame payload is divided into blocks to be input to the authentication and encryption/decryption process for MIC and cipher text computation and plain text recovery. Unencrypted or decrypted frame payload 201 is divided into a plurality of payload blocks B₁, , , , Bₘ (202). Each block Bᵢ 202 preferably is sixteen octets long and is encoded with the octet containing the most-significant bits on the left and the octet containing the least-significant bits on the right. Zero padding 203 preferably is added to payload data 201 to from the final block Bₘ if the frame payload is not an integral multiple of sixteen octets. Accordingly, the final block Bₘ preferably contains no zero-padded octets if the frame payload length was evenly divisible by sixteen, or contains one or more zero-padded octets on the right end if the frame payload length was not evenly divisible by sixteen.

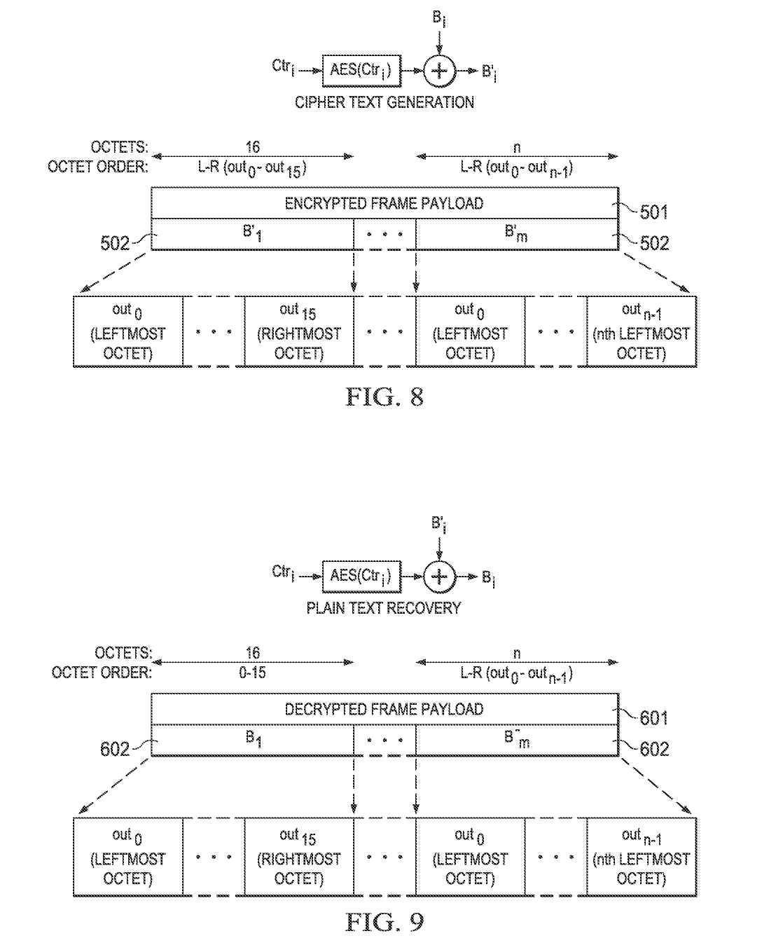

FIG. 6 illustrates an exemplary format for counter blocks Ctrᵢ that are used for inputs to a cipher block chaining-based MIC computation and to a counter mode encryption. Each data block being encrypted has a unique counter block. Block Ctr₀ is the input block to the counter mode encryption of the cipher block chaining (CBC) output for MIC computation. Blocks Ctr₁, . . . , Ctrₘ are the input blocks to the counter mode encryption/decryption if the frame payload is to be encrypted/decrypted. Blocks Ctr₁, . . . , Ctrₘ are each sixteen octets long, with the constitutent fields each encoded with the octet containing the most-significant bits on the left and the octet containing the least-significant bits on the right. Counter block Ctr₁ comprises flags field 301, nonce field 302, and a counter value field 303. Flags field 301 may have a fixed value 0x01 in one embodiment. Nonce field 302 is computed as described below with respect to FIG. 8. Counter i field 303 is incremented for the values i=0, . . . , m.

FIG. 7 illustrates an exemplary format for constructing a nonce used in message authentication and encryption/decryption processes. The nonce illustrated in FIG. 9 is used, for example, in field 103 of input blocks B₀ in FIG. 4 and in field 302 of counter block Ctri in FIG. 8. The nonce preferably is 13 octets long and comprises leading zeros 401, header 402, and security sequence number (SSN) 403.

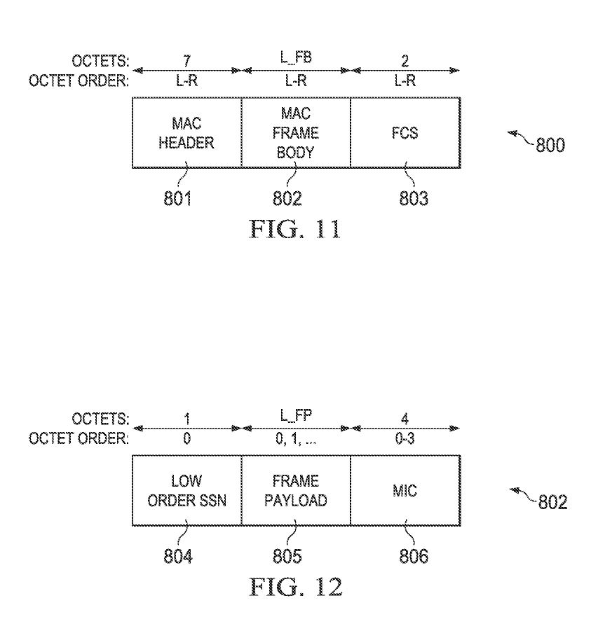

Header field 402 comprises medium access control (MAC) frame header information, such as the address for the sender and recipient of the frame and frame control data. Header field 402 may be populated using data from MAC header field 801 in frame 800 as described below (FIG. 11).

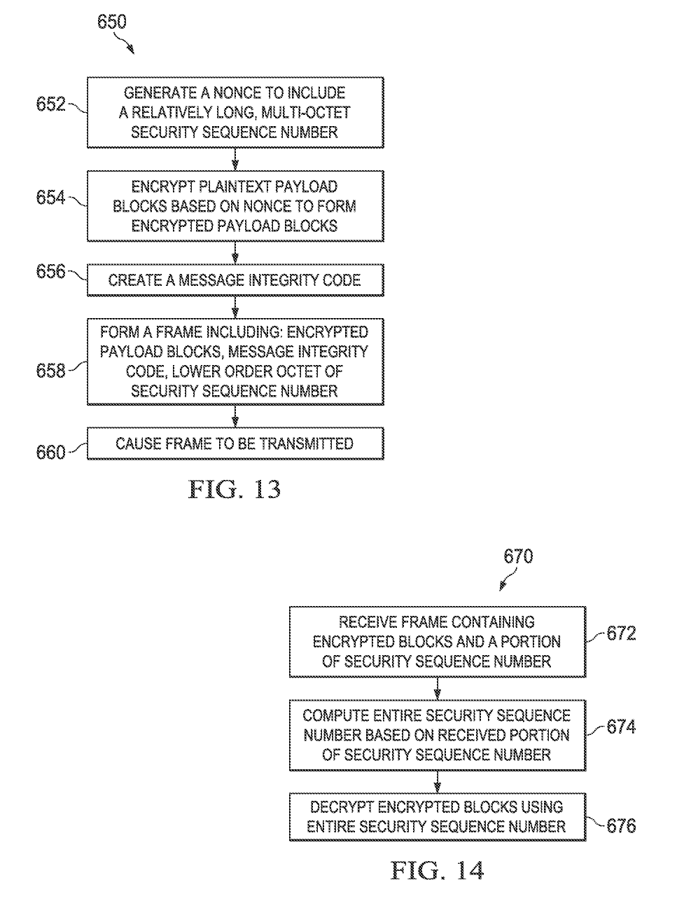

The SSN 403 in the nonce is the complete SSN. In the example in which the SSN is 4 octets long, all 4 octets of the SSN are included as part of the nonce, even though only a portion of the SSN is wirelessly transmitted as explained above. SSN field 403 may be populated from low-order security sequence number field 804 contained in frame body 802 as described below (FIG. 12) and from an internally tracked high-order security sequence number as described earlier. In one embodiment, the security sequence number field 403 is set as follows for nonce construction. For frames secured with a new pairwise temporal key (PTK), SSN field 403 is set to 0. For frames secured with a used PTK, whether transmitted for the first time or as retries, the SSN field 403 is incremented by one from its value in the last transmitted frame secured with the same PTK. The value of the SSN field 403 increments in frames secured with the same PTK, rather than in frames of the same frame type or frame subtype. It increments even if the current frame transmission is a retransmission of an earlier transmission. For each secured frame, the low-order security sequence number field 403 has the same value as the namesake field 801 contained in the frame body shown in FIG. 13.

FIG. 8 illustrates a cipher text generation procedure and a format of an encrypted frame payload 501 in an encrypted frame according to one embodiment of the invention. Blocks B′ 502 for the encrypted frame payload are computed with the payload blocks B and counter blocks Ctr formatted earlier as follows:

B′ᵢ=BᵢXORAES(Ctrᵢ),i=1, . . . ,m−1 (1)

B′ₘ=L_{—}n(Bₘ)XORL_{—}n(AES(Ctrₘ)) (2)

Here, XOR denotes a bitwise exclusive-OR operation, and L_n(B) designates the n leftmost octets of B. AES(Ctrᵢ) represents the output of the forward cipher function of the AES block cipher algorithm applied to the counter block Ctrᵢ under the AES key PTK used to secure the frame. The encrypted frame payload has the same length as the unencrypted frame payload, so that n≦16 is the number of octets in Bₘ excluding zero padding octets, if any. Each encrypted block is ordered for transmission from its first octet on the left to its last octet on the right. The octet notations out0, . . . , out15 correspond to those used for AES output block formation specified in FIPS Pub 197.

FIG. 9 illustrates a plain text recovery procedure and a format of a decrypted frame payload 601 in a decrypted frame according to one embodiment of the invention. Plain text payload blocks B are decrypted from the encrypted frame payload using the following equations:

Bᵢ=b′iXORAES(Ctrᵢ),i=1, . . . ,m−1 (3)

B⁻ₘ=B′ₘXORL_{—}n(AES(Ctrₘ)) (4)

The decrypted frame payload 601 has the same length as the encrypted frame payload, so that the number of octets in the last block B′ₘ of the received encrypted frame payload is n≦16. The last decrypted block B⁻ₘ is padded with 16-n zero octets at the right end to form the last block Bₘ for MIC calculation over the received frame as described below.

Each unencrypted or decrypted block is ordered for MIC calculation from its first octet on the left to its last octet on the right. The unencrypted or decrypted payload is delivered to the destination client if the MIC is valid. Again, the octet notations out0, . . . , out15 correspond to those used for AES output block formation specified in FIPS Pub 197.

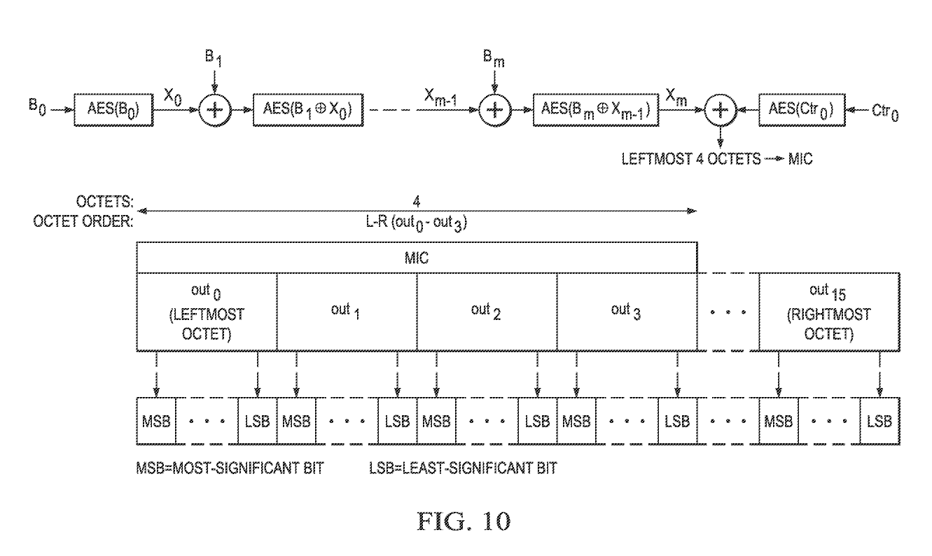

FIG. 10 illustrates a procedure for message integrity code (MIC) calculation according to one embodiment of the invention. The MIC for an authenticated message is calculated using the following equations:

MIC=LMB_{—}n(M),M=AES(Ctr₀)XORXₘ (5)

X₀=AES(B₀),Xᵢ=AES(BᵢXORXᵢ₋₁),i=1, . . . ,m (6)

That is, block B₀ (which includes the nonce as shown in FIG. 4) is encrypted using the temporal key (TK) to compute X₀, and X₀ is then exclusive-OR'd with block B₁, with the result encrypted using TK to produce X₁. The process continues in this chain fashion until Xₘ is computed. Xₘ is then exclusive-OR'd with the encrypted version of Ctr₀ (which also includes the nonce) to compute the MIC. The MIC value is thus unique to the data blocks (B₁, . . . , Bₘ) as well as the nonce which includes the SSN. On the receive side, once the receive device 70 decrypts the encrypted data blocks, the receive device computes the MIC and compares its computed MIC to the received MIC value of the frame. If the two MICs do not match, the frame is deemed not to be authenticated and is thus considered invalid. However, if the MICs match, the frame is deemed authenticated and valid.

The MIC is ordered for transmission by the sender device 52 from its first octet on the left to its last octet on the right. The blocks required for the MIC computation are constructed on the sender side from the unencrypted version of the frame to be transmitted and on the recipient side from the decrypted version of the received frame, if the received frame is encrypted.

FIG. 11 illustrates a MAC frame 800 comprising a frame header 801, frame body 802, and frame check sequence (FCS) 803. The data in frame 800 is used to create the nonce, blocks B₀ through Bₘ and counter Ctrᵢ that are used to secure the frames as described above in FIG. 4-9. MAC header 801 includes sender and recipient address information and frame control data. Frame body 802 is described in additional detail in FIG. 14.

FIG. 12 illustrates a frame body, such as MAC frame body 802, which includes a portion of the SSN 804, frame payload 805, and message integrity code (MIC) 806. The portion of the SSN 804 included in the MAC frame body preferably is the lower order portion (e.g., the lowest order octet) as explained above. The full SSN is used to compute the MIC by the sender device 52. The receiver device 70 receives the portion 804 and computes the full SSN to again compute a MIC for authentication purposes.

The frame body further includes frame payload 805 of length L_FB. The frame payload field 805 is set as follows. For data frames that are not encrypted, frame payload field 805 is set to a sequence of octets passed as a service data unit without altering the order of the sequence. For encrypted management or data frames, frame payload 805 is set to the encrypted frame payload, i.e., the cipher text of the frame payload that would otherwise be communicated in a frame not encrypted.

The MIC field 806 is set to a message integrity code (MIC) for preserving the authenticity and integrity of the header and frame body of the secured frame containing the current message, as specified above and calculated using equations (5) and (6). Message authenticity and integrity is provided in embodiments of the present invention using the message integrity code (MIC), which functions as a security check sum to protect against forged or changed data.

Message confidentiality and privacy is provided using message encryption, such as the AES-128 forward cipher function.

Anti-replay protection is achieved by the cooperative efforts of the sender and receiver devices. The sender device 52 computes a MIC as noted above. The MIC is computed based on the data blocks and the complete SSN. The SSN is unique to each frame and to each key. The receiver device receives the frame with the SSN portion 804 and computes the entire SSN as explained above. The receiver device increments the value in the higher order octets if the newly received SSN portion 804 is less than or equal to the immediately previously received SSN portion (a situation which may be indicative of the fact that the SSN portion 804 has simply wrapped around once it reached all 1's). If, however, the sender is engaged in a replay attack and is simply resending an exact copy of a frame, the SSN portion 804 in the subsequently received copy of the frame will be the same as in the previous frame. The receiver device will act by computing the complete SSN with an increment to the higher order octets. At that point, the SSN used by the sender device will not match the SSN computed by the receiver device, and the frame will not be authenticated due to mismatching MICs (MIC in the frame versus MIC computed by the receiver device). The replay attack will thus be detected and the receiver device may discard the replayed frames. The inherent detection of replay attacks is an advantageous side effect of how SSNs are sent and computed in accordance with the embodiments described above. Consequently, the receiver device 70 need not perform a separate replay attack detection process.

The preferred embodiments of the encryption/decryption and authentication technique described herein advantageously uses a relatively long SSN value, which avoids having to change the keys as often as if a shorter SSN value were to be used. Yet, at the same time, the entire SSN value is not transmitted from sender device to receiver device reducing the burden on communication bandwidth.

FIG. 13 shows a preferred embodiment of a method 650 performed by the sender device 52. The actions depicted may be performed in the order shown or in a different order. The actions may be performed, for example, by the processor 81 executing code stored in storage device 86.

At 652, the method includes generating a nonce to include a relatively long, multi-octet (e.g., 4 octets) SSN. At 654, the method includes encrypting plaintext payload blocks based on the nonce to form encrypted payload blocks and at 656 creating a MIC). At 658, the method further includes forming a frame including the encrypted payload blocks, the MIC, and a lower order octet of the SSN (e.g., the lowest order octet), but not the entire SSN. Finally, the method includes causing the frame to be transmitted (660). In some embodiments, causing the frame to be transmitted includes providing the frame to the transmitter 64 (FIG. 1) or transceiver 82 (FIG. 3), while in other embodiments, causing the frame to be transmitted includes actually transmitting (e.g., wirelessly) the frame.

FIG. 14 shows a preferred embodiment of a method 670 performed by the receiver device 70. The actions depicted may be performed in the order shown or in a different order. The actions may be performed, for example, by the processor 81 executing code stored in storage device 86.

At 672, the method includes receiving the frame, which may include encrypted blocks of data and a portion of an SSN, but not the entire SSN. For example and as explained above, the received SSN portion may be the lowest order octet of a 4-octet SSN. At 674, the method further includes computing the entire SSN based on the received portion. At 676, the method also includes decrypting the encrypted blocks using the entire SSN.

In some embodiments, the sender and receiver devices use the entire SSN (but transmit only a portion of the SSN) for both frame encryption and authentication. In other embodiments, the sender and receiver devices use the entire SSN (but transmit only a portion of the SSN) for frame authentication but not encryption.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A method for secure communications between devices, comprising:
generating a nonce to include a multi-octet security sequence number (SSN);
encrypting plaintext payload blocks based on said nonce to form encrypted payload blocks;
creating a message integrity code (MIC);
forming a frame including the encrypted payload blocks, the MIC, and a lower order portion of the SSN, but not the entire SSN; and
causing the frame to be transmitted.

2. The method of claim 1, wherein the SSN is a 4 octet number and the lower order portion is a lowest order octet of the 4 octet value.

3. The method of claim 1 wherein encrypting the plaintext payload blocks includes encrypting the payload blocks using all octets of the multi-octet SSN.

4. A method for secure communications between devices, comprising:
receiving a frame containing a message authentication code (MIC) and containing either encrypted or plaintext blocks and a portion, but not all, of a security sequence number (SSN);
computing the entire SSN based on the received portion;
authenticating the received frame using the entire SSN; and
if the blocks comprise encrypted data, decrypting the encrypted blocks using the entire SSN.

5. The method of claim 4 wherein authenticating the received frame comprises computing a MIC for the received frame based on the entire computed SSN.

6. The method of claim 4 wherein the received portion of the SSN is a lowest order octet, and wherein computing the entire SSN comprises.
incrementing a higher order portion of the SSN by one when the received portion of the SSN is not larger than a last received portion of an SSN and the last received portion of an SSN was contained in a frame with a valid MIC value.

7. The method of claim 4 further comprising verifying a message integrity code (MIC) in the received frame using the entire computed SSN.

8. The method of claim 7 wherein computing the entire SSN comprises incrementing a higher order portion of the SSN by one when the received lower order portion of the SSN is not larger than a last received portion of an SSN and the last received portion of an SSN was contained in a frame with a valid MIC value.

9. The method of claim 7 wherein the received portion of the SSN and the last received portion of an SSN were contained in frames sent from a common sender to a common receiver.

10. A device, comprising:
an encryption and authentication engine to receive plaintext data blocks as input, to generate encrypted data blocks using a key and a complete multi-octet security sequence number (SSN), to compute a message integrity code (MIC) based on the complete SSN, and to form a frame containing the encrypted data blocks, the MIC, and a portion of the SSN, but not the entire SSN;
a transmitter coupled to the encryption and authentication engine to transmit the frame to another device.

11. The device of claim 10 wherein the portion of the SSN included in the frame is the lowest order octet of the SSN.

12. The device of claim 10 wherein the encryption and authentication engine increments the SSN with each subsequent frame formed and with a same key used by the encryption and authentication engine.

13. A device, comprising:
an engine to generate a message integrity code (MIC) for a frame based on a complete multi-octet security sequence number (SSN) and to form a frame containing data, the MIC, and a portion of the SSN, but not the entire SSN; and
a transmitter coupled to the engine to transmit the frame to another device.

14. The device of claim 13 wherein the engine also receives plaintext data as input and generates encrypted data blocks using a key and the complete multi-octet SSN.

15. A device, comprising:
a receiver to receive a frame including encrypted data blocks and a portion of a security sequence number (SSN), but not the entire SSN; and
a decryption and authentication engine to compute the entire SSN based on the received SSN portion and to perform at least one of authentication of the received frame based on the entire SSN and decryption of the encrypted data blocks received in the frame using the entire SSN.

16. The device of claim 15 wherein the decryption and authentication engine computes a message integrity code (MIC) for the received frame based on the entire computed SSN.

17. The device of claim 15 wherein the received portion of the SSN is a lower order octet, and wherein the decryption and authentication engine computes the entire SSN by incrementing a higher order portion of the SSN by one when the received portion of the SSN is not larger than a last received portion of an SSN and the last received portion of an SSN was contained in a frame with a valid MIC value.

18. The device of claim 16 wherein the decryption and authentication engine verifies a message integrity code (MIC) in the received frame using the entire computed SSN.

19. The device of claim 15 wherein the decryption and authentication engine computes the entire SSN by incrementing a higher order portion of the SSN by one when the received portion of the SSN is not larger than a last received portion of an SSN and the last received portion of an SSN was contained in a frame with a valid MIC value.

20. The device of claim 19 wherein the received portion of the SSN and the last received portion of an SSN were contained in frames sent from a common sender to a common receiver.

21. A method for secure communications, comprising:
generating a nonce to include a complete multi-octet security sequence number (SSN);
creating a message integrity code (MIC) based on nonce with the complete SSN;
forming a frame including payload blocks, the MIC, and a lower order portion of the SSN, but not the complete SSN; and
causing the frame to be transmitted.

22. The method of claim 21 further comprising encrypting plaintext payload blocks based on said nonce with the complete SSN to form encrypted payload blocks, and replacing the payload blocks with the encrypted payload blocks in the frame.

23. The method of claim 21 wherein the lower order portion of the SSN included in the frame is a lowest order octet of the SSN.
